(19) United States
(12) Patent Application Publication
(10) Pub. No.: US 2025/0011194 A1
(43) Pub. Date: Jan. 9, 2025

(54) System and Method for the Treatment of Drinking Water

(71) Applicant: BWT Holding GmbH, Mondsee (AT)

(72) Inventors: Katharina WEITGASSER, Wals (AT); Jürgen JOHANN, Mondsee (AT)

(73) Assignee: BWT Holding GmbH, Mondsee (AT)

(21) Appl. No.: 18/711,642

(22) PCT Filed: Nov. 17, 2022
(86) PCT No.: PCT/EP2022/082247

§ 371 Date: May 20, 2024

(30) Foreign Application Priority Data
Nov. 22, 2021 (DE) 10 2021 130 491.1

(51) Int. Cl. C02F 1/42; B01J 39/09; B01J 47/026; B01J 49/53; C02F 1/66; C02F 1/68

(52) U.S. Cl. CPC C02F 1/42; B01J 39/09; B01J 47/026; B01J 49/53; C02F 1/66; C02F 1/688; C02F 2001/425; C02F 2201/006; C02F 2301/043; C02F 2301/08; C02F 2303/16

(57) ABSTRACT

The invention relates to a system for the treatment of drinking water, comprising a softening system with an ion exchanger. This ion exchanger is regenerated using an alkali salt, in particular sodium chloride or potassium chloride.

Downstream of the water softening system and upstream of an extraction point, an ion exchanger loaded with hydrogen is arranged followed by a mineralization material which releases calcium, magnesium, and/or silicon.

### CROSS-REFERENCE TO RELATED APPLICATION

This application is a national stage application, filed under 35 U.S.C. § 371, of International Patent Application PCT/EP2022/082247, filed on Nov. 17, 2022, which claims the benefit of German Patent Application DE 10 2021 130 491.1, filed on Nov. 22, 2021.

### TECHNICAL FIELD

The disclosure relates to a system and to a method for the treatment of drinking water. More particularly, the disclosure relates to a system comprising a water softening system for drinking water. The disclosure also relates to a cartridge for increasing mineralization which is designed for such a system.

### BACKGROUND

Water softening systems such as those used in households and in the industry/catering sector, often comprise an ion exchanger which is regenerated using a salt solution. One such system is marketed by the Applicant under the trade name BWT Aqua Perla.

During operation, the input water is passed through the ion exchanger. In this process, hardness imparting substances, especially calcium and magnesium, are exchanged for sodium or potassium. This involves concentration-dependent equilibrium reactions. Once exhausted, the ion exchanger can therefore be regenerated using a concentrated salt solution, in particular a table salt solution.

The water softened by such a system will therefore have a relatively high sodium content which is proportional to the hardness of the input water. Such water can be optimally used for laundry and for cleaning purposes. In particular the installation system and surfaces in the bathroom and kitchen will be protected from limescale deposits.

Sodium is an essential element for the body, which in particular regulates the body's water balance and blood pressure. Sodium is also important for cell maintenance and for the generation and transmission of nerve impulses.

The recommended upper limit for table salt consumption is 6 g per day. However, the average table salt consumption of the population is usually much higher. This is due to convenience foods and processed animal products such as sausages and cheese. An excess supply of sodium can lead to health problems, particularly in risk groups such as diabetics or people with kidney disease. Sodium binds water in the body and in the blood vessels, which can lead to an increase in blood pressure. The increased water loss via the kidneys can also lead to calcium being excreted, which might increase the risk of osteoporosis.

The water treated with the water softening system as described above is therefore usually not optimal for drinking.

Moreover, the water softening system can usually only be adjusted to a limited extent to still provide enough calcium and magnesium for the drinking water. If the degree of softening is reduced by setting a blending ratio via a bypass, the amount of calcium and magnesium in the water will in fact increase, but at the same time limescale protection will decrease accordingly.

Devices and methods for the treatment of drinking water are known from documents DE 10 2019 132 319 A1, DE 10 2018 116 266 A1, DE 10 2012 007 149 A1, and DE 10 2010 023 612 A1.

### SUMMARY

Given this background, the disclosure is based on the object of at least mitigating the above-mentioned drawbacks of the prior art. More particularly, it is an object of the disclosure to provide a system and a method for treating drinking water, which allows to provide water that is low in sodium and potassium but at the same time contains calcium or magnesium and which still allows to achieve sufficient limescale protection.

The object is achieved by a system and a method for the treatment of drinking water and by a cartridge designed for such system as disclosed and claimed.

The disclosure relates to a system for the treatment of drinking water. More particularly, the disclosure relates to a system that can be used in a household and in the catering sector, for example, for treating tap water.

The system comprises a water softening system including an ion exchanger that can be regenerated using an alkali salt. In particular, the softening system can be regenerated using sodium chloride or potassium chloride.

In addition to the ion exchanger, the water softening system comprises a brine tank for this purpose. Once the ion exchanger material is exhausted, a control system will cause concentrated salt brine to be passed through the ion exchanger, whereby the ions deposited there (e.g. calcium and magnesium) will be exchanged for sodium or potassium.

An ion exchanger loaded with hydrogen is arranged downstream of the softening system and upstream of an extraction point, followed by a mineralization material which releases calcium, magnesium and/or silicon.

It is in particular envisaged that the system comprises a plurality of extraction points, and that the water is passed through the ion exchanger loaded with hydrogen and through the mineralization material only at at least one extraction point from which water is to be dispensed for drinking purposes.

First, the ion exchanger loaded with hydrogen is used to exchange the sodium or potassium for hydrogen. The water is then passed through the mineralization material whereby calcium, magnesium and/or silicon is released into the water.

Due to the use of the hydrogen-loaded ion exchanger, the pH value is reduced when potassium ions and sodium ions are replaced by hydrogen ions.

During the mineralization the pH will increase again. However, with appropriate dimensioning of the ion exchanger and the mineralization material, the pH can be adjusted so that it will be below 7, in particular between 5.5 and 6.5.

With the slightly acidic water in this way, sufficient limescale protection will be achieved despite the presence of calcium and magnesium in the water, since the water will still have limescale dissolving capacity.

The ion exchanger loaded with hydrogen may be a strongly acidic ion exchanger. Such ion exchangers include, for example, sulfonic acid groups. However, a weakly acidic ion exchanger, in particular with carboxyl groups, can also be used.

The hydrogen-loaded ion exchanger and the mineralization material are preferably provided inside a cartridge, in particular in a single cartridge.

In order to prevent the ion exchanger from dissolving the calcium ions or magnesium ions from the mineralization material during stagnation operation, the materials are provided in separate chambers, in particular with a backstop between the chambers.

The mineralization material is preferably provided in the form of granules. More particularly, granules with an average particle size from 0.5 to 10 mm, preferably from 2 to 6 mm, can be used. The granules may in particular have a spherical shape. Such a design ensures that the mineralization material will only dissolve slowly, so that a long-lasting even release is achieved.

The mineralization material may comprise magnesium oxide and/or calcium oxide, magnesium hydroxide and/or calcium hydroxide, magnesium carbonate and/or calcium carbonate, or silicon dioxide.

The mineralization material may in particular comprise calcium hydroxide granules and magnesium carbonate granules. These two materials may in particular be provided in a mixed bed.

The disclosure furthermore relates to a cartridge which is designed for the above mentioned system. The cartridge comprises a first chamber including the ion exchanger loaded with hydrogen and a second chamber including the mineralization material.

Preferably, a backflow preventer or backstop is provided between the chambers. Instead of a backstop, a sufficiently long pipe section may be connected therebetween so as to ensure that no acidic water from the ion exchanger gets into the mineralization material.

The disclosure furthermore relates to a method for treating drinking water, in particular using the system as described above.

The input water is directed through an ion exchanger which is loaded with alkali ions, in particular sodium ions and potassium ions. Hardness imparting substances such as magnesium and calcium are thereby partially or completely removed, so that the water will now be soft.

The soft water is supplied to an installation system which has a plurality of extraction points. Upstream of at least one extraction point, the water is first passed through an ion exchanger loaded with hydrogen and then through a mineralization material which releases calcium, magnesium, or silicon.

It is in particular envisaged to have at least one additional extraction point to which the water containing alkali ions from the water softening system is fed directly. For example, only extraction points that are used to dispense drinking water will be equipped with a cartridge which removes the sodium from the water using the ion exchanger loaded with hydrogen and enriches the water with magnesium and calcium using the mineralization material.

Depending on the ion concentration in the water, the hydrogen-loaded ion exchanger will acidify the water by virtue of a carbonic acid equilibrium that will be established, in particular to a pH value of between 2.0 and 4.5.

The mineralization material will in turn increase the pH value. The quantitative percentages of ion exchange material and mineralization material are preferably selected such that the output water will be adjusted to a pH between 5.5 and 6.8, preferably 5.8 to 6.5. After having passed through the hydrogen-loaded ion exchanger, sufficient salt ions will preferably have been removed so that the sodium or potassium content will be less than 5 mg/l, preferably less than 2 mg/l.

The mineralization material allows the output water to be adjusted to a calcium content of between 10 and 40 mg/l, preferably 15 to 30 mg/l, and/or to a magnesium content of between 15 and 40 mg/l, preferably 20 to 30 mg/l.

### BRIEF DESCRIPTION OF THE DRAWINGS

The subject-matter of the invention will now be explained in more detail by way of an exemplary embodiment with reference to the drawings of FIGS. 1 through 7.

FIG. 1 is a schematic diagram of a system for the treatment of drinking water.

FIG. 2 is a schematic diagram of the cartridge used for the system.

FIG. 2a shows an alternative embodiment which uses two separate cartridges.

FIGS. 3 to 6 are graphs showing the contents of sodium, magnesium, calcium, and the pH, respectively, of the water after having passed through the water softening system, after having passed through the hydrogen-loaded ion exchanger, and after having passed through the mineralization material.

FIG. 7 is a flow chart illustrating the method for treating drinking water.

### DETAILED DESCRIPTION

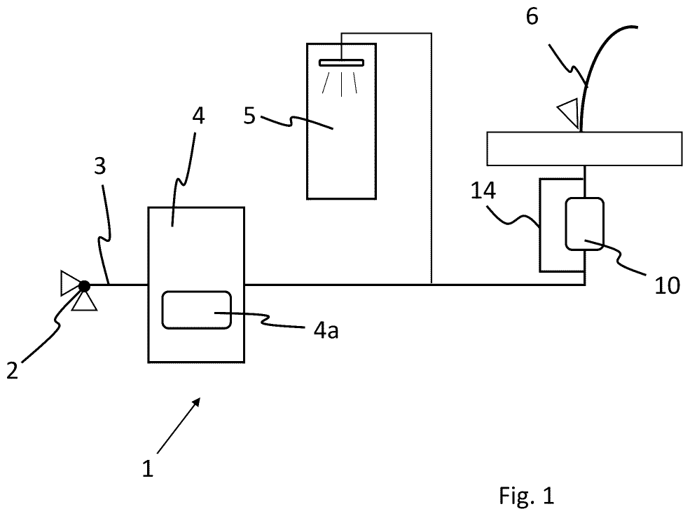

FIG. 1 is a schematic diagram showing a system 1 for the treatment of drinking water.

The system 1 can in particular be used in the household and in the catering sector.

Via a water connection 2, the input water flows through a pipe 3 and into the installation system.

First, the water flows into a water softening system 4. The softening system 4 contains an ion exchanger loaded with sodium. Hardness imparting substances in the water are exchanged for sodium ions.

The system comprises a brine tank 4a which is filled with salt in order to regenerate the system 1 at regular intervals using a corresponding control system (not shown).

The brine used for regeneration is fed to a drain (not shown).

Downstream of the softening system 4, the installation system branches off. Water from the softening system 4 is directly supplied to extraction points 5 where the water is not used for drinking, such as a shower, a washing machine, or a toilet.

At an extraction point 6 such as a tap or water dispenser, where water is to be withdrawn for drinking purposes, a cartridge 10 is provided upstream of the extraction point 6, which cartridge comprises a chamber containing an ion exchanger loaded with hydrogen and a chamber containing the mineralization material.

The cartridge 10 serves to remove the sodium from the water fed from the softening system 4 and to add calcium and magnesium and optionally also silicon.

If it is desired to not completely remove the sodium, a bypass 14 may be routed around the cartridge 10 to feed part of the water therethrough.

The bypass 14 is preferably adjustable with regard to the blending quantity.

The cartridge 10 is preferably designed so as to be replaceable, for example in the form of a replaceable filter candle.

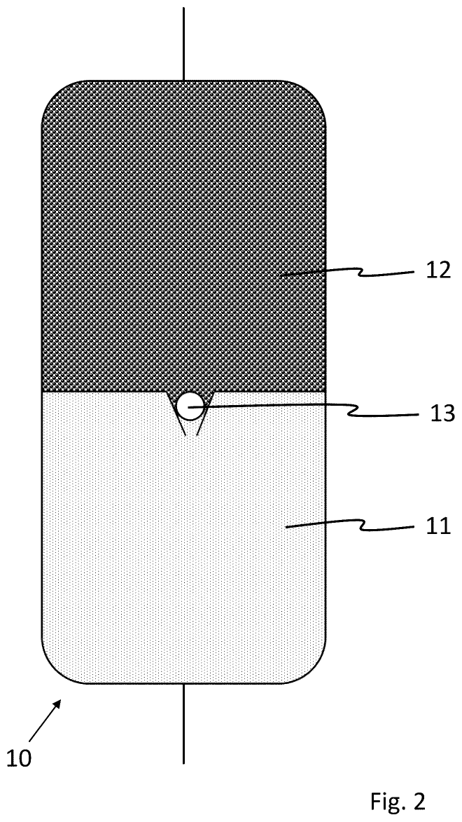

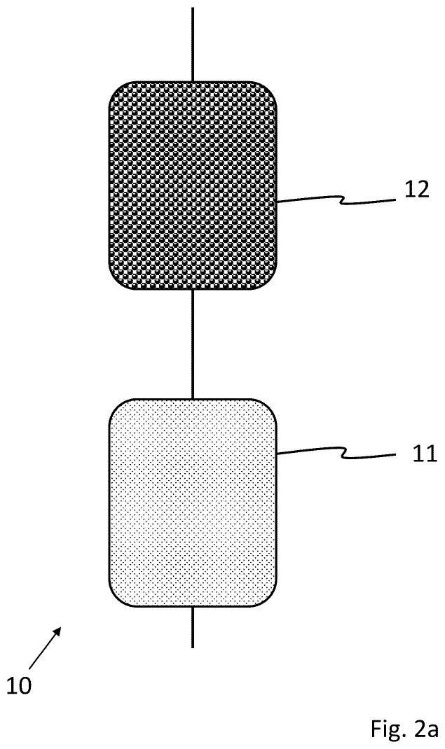

FIG. 2 is a schematic diagram of the cartridge 10.

The cartridge is divided into two chambers 11 and 12.

The ion exchange material loaded with hydrogen is contained in the upstream first chamber 11. It may, for example, be in the form of granules made of an ion exchange resin.

The following chamber 12 downstream thereof is filled with the mineralization material.

The mineralization material may in particular be in the form of granules comprising grains which include 70 to 90 wt % of magnesium carbonate, 2 to 10 wt % of magnesium hydroxide, and optionally 2 to 10 wt % of silicon dioxide. This material releases magnesium into the water.

Furthermore, the granules may comprise grains which include 70 to 90 wt % of calcium hydroxide, 10 to 20 wt % of calcium carbonate, and optionally 1 to 5 wt % of silicon dioxide. This material releases calcium into the water.

The granules may in particular have a spherical shape, and the average particle size may range between 0.5 and 10 mm.

Such a material ensures sufficiently slow dissolution.

FIG. 2a shows an alternative embodiment in which the hydrogen-loaded ion exchanger is provided in a first chamber 11 which is connected to the second chamber 12 which holds the mineralization material by a pipe section.

Thus, the ion exchanger and the mineralization material are provided in separate chambers, especially cartridges.

The intermediate pipe section ensures that, even without a backflow preventer, the ion exchanger loaded with hydrogen will not dissolve the mineralization material by exchanging hydrogen for calcium and magnesium from the mineralization material.

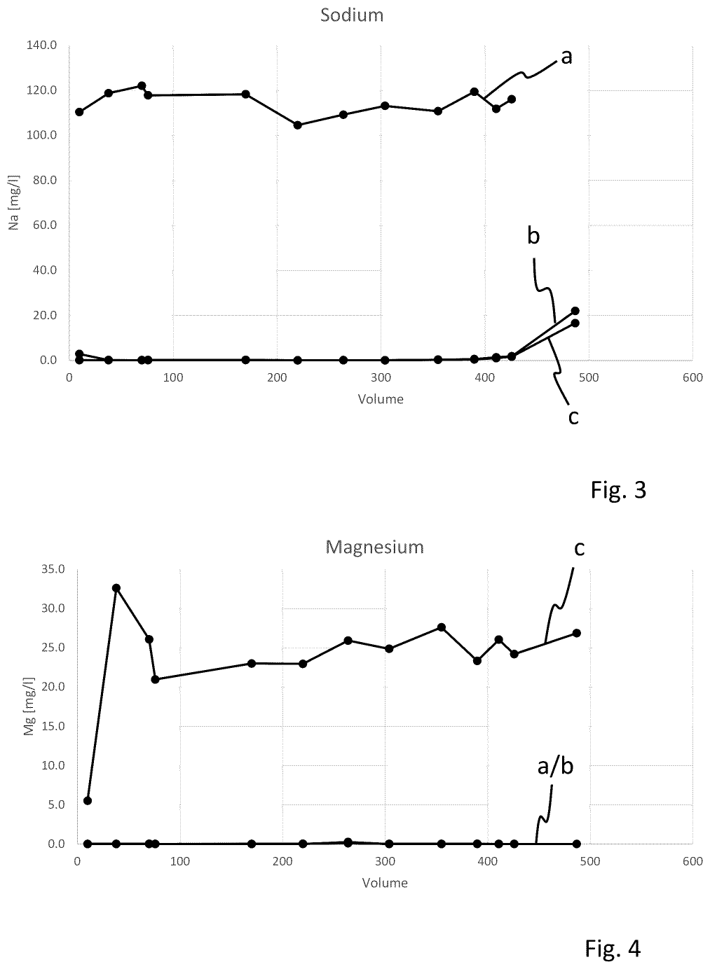

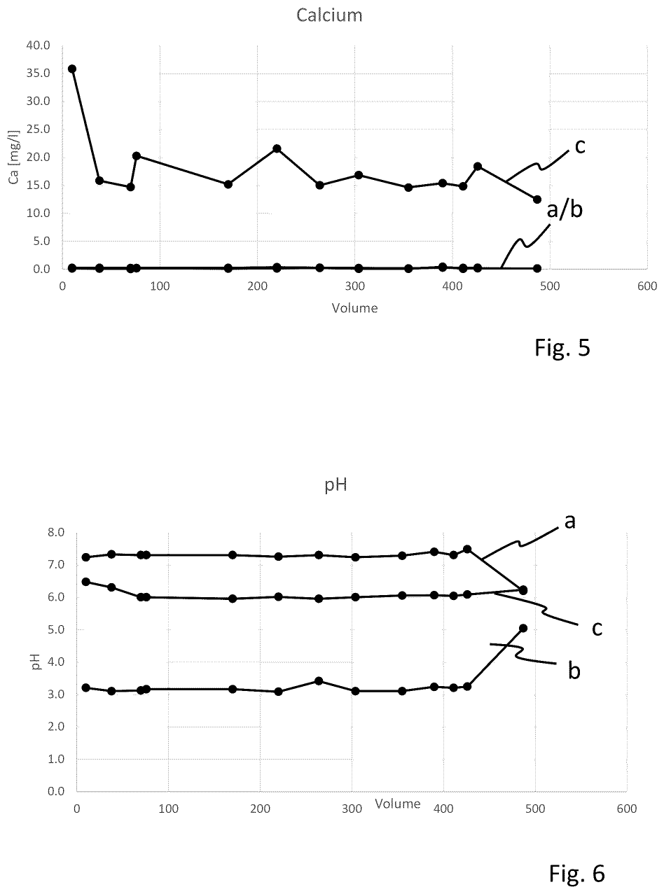

FIGS. 3 to 5 are graphs showing the contents of sodium, magnesium and calcium, respectively, of a) the water downstream of the water softening system, b) the water after having passed through the ion exchanger loaded with hydrogen, and c) after having passed through the mineralization material. The filtered volume in liters is plotted on the x-axis, and the respective content in mg/l is plotted on the y-axis.

FIG. 3 shows that, after having passed through the softening system, the sodium content of the water is quite high, in particular more than 100 mg/l.

By contrast, after having passed through the ion exchanger loaded with hydrogen, the sodium content is below 10 mg/l, in particular approximately 0, over the entire service life of the cartridge.

FIG. 4 shows that, once the mineralization material begins to dissolve, the magnesium content after passing through the mineralization material is adjusted to more than 20 mg/l, whereas before it was below 5, in particular nearly 0.

The same applies to the calcium content.

The calcium content is adjusted to a value of more than 10 mg/l, while before passing through the mineralization material it is below 5 mg/l, in particular approximately 0.

Similarly to the previous figures, FIG. 6 shows the pH of the water in the flow path.

After having passed through the softening system, the water has a neutral to slightly basic pH value.

The hydrogen-loaded ion exchanger acidifies the water to a pH below 4 until it is exhausted.

The mineralization material ultimately increases the pH value again and adjusts it to a slightly acidic pH between 6 and 6.5. Despite the presence of calcium and magnesium, sufficient protection against limescale is ensured.

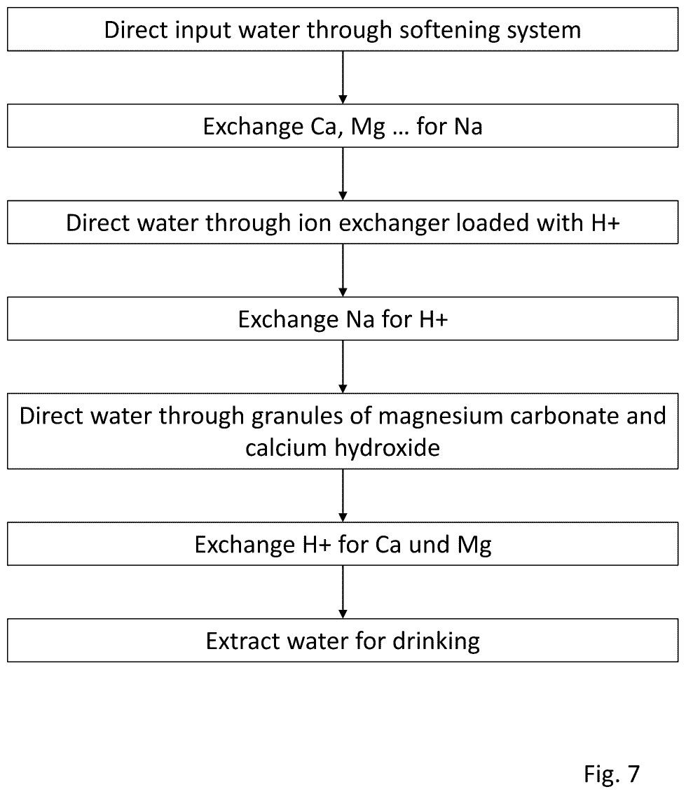

FIG. 7 shows the method steps according to an exemplary embodiment of the method for treating drinking water.

The input water from the water pipe is passed through a water softening system. The hardness imparting substances calcium and magnesium are replaced by sodium.

The sodium-containing water is now passed through the hydrogen-loaded ion exchanger, whereby the sodium is exchanged for hydrogen and is preferably almost completely removed from the water.

The water is then passed through granules of magnesium carbonate and calcium hydroxide.

These materials slowly dissolve and release calcium and magnesium into the water.

This water, which is low in sodium but contains calcium and magnesium, can be used at an extraction point for drinking.

The invention made it possible to provide, in a simple way, a system which despite ensuring good limescale protection, allows to provide water which is low in sodium and potassium and at the same time rich in minerals at extraction points that are used to dispense water for drinking purposes.

### LIST OF REFERENCE SYMBOLS

a Water downstream of softening system
b Water after having passed through the hydrogen-loaded ion exchanger
c Water after having passed through the mineralizing material
1 System for treating drinking water
2 Water connection
3 Pipe
4 Decalcification system
4a Brine tank
5 Extraction point
6 Extraction point
10 Cartridge
11 First chamber
12 Second chamber
13 Backstop
14 Bypass

1.-15. (canceled)

16. A system for treating drinking water, comprising:
a softening system including a first ion exchanger which is regenerated using an alkali salt;
a second ion exchanger loaded with hydrogen arranged downstream of the softening system and upstream of an extraction point; followed by
a mineralization material which releases calcium, magnesium and/or silicon.

17. The system of claim 16,
wherein the alkali salt is sodium chloride or potassium chloride.

18. The system of claim 16,
wherein the mineralization material is in form of granules with an average particle size from 0.5 to 10 mm.

19. The system of claim 16,
wherein the mineralization material is in form of granules with an average particle size from 2 to 6 mm.

20. The system of claim 16,
wherein the mineralization material comprises magnesium oxide and/or calcium oxide, magnesium hydroxide and/or calcium hydroxide, magnesium carbonate and/or calcium carbonate, and/or silicon dioxide.

21. The system of claim 16,
wherein the mineralization material comprises calcium hydroxide granules and magnesium carbonate granules.

22. The system of claim 16,
wherein the second ion exchanger and the mineralization material are provided in a common housing which comprises two separate chambers.

23. The system of claim 22,
wherein a backstop is arranged between the two separate chambers.

24. The system of claim 16,
wherein a bypass is routed around the second ion exchanger and/or the mineralization material.

25. A cartridge designed for the system of claim 16, comprising
a first chamber containing the second ion exchanger and
a second chamber containing the mineralization material.

26. The cartridge of claim 25, further comprising
a backstop arranged between the first chamber and the second chamber.

27. A method for treating drinking water, comprising:
directing water through a first ion exchanger which is loaded with sodium ions or potassium ions;
supplying the water to an installation system having a plurality of extraction points; and
passing the water first through a second ion exchanger loaded with hydrogen and then through a mineralization material which releases calcium, magnesium, and/or silicon upstream of one of the plurality of extraction points.

28. The method of claim 27, further comprising
adjusting the water to a pH of between 5.8 and 6.5 by the second ion exchanger.

29. The method of claim 27, further comprising
directing the water from the first ion exchanger to a further one of the plurality of extraction points without passing through the second ion exchanger and through the mineralization material.

30. The method of claim 27, further comprising
using the mineralization material to adjust the water to a calcium content of between 15 to 30 mg/l, and/or to a magnesium content between 20 to 30 mg/l.

31. A system adapted to carry out the method according to claim 27.
